(19) United States
(12) Patent Application Publication
(10) Pub. No.: US 2024/0087185 A1
(43) Pub. Date: Mar. 14, 2024

(54) VIRTUAL VIEW DRAWING METHOD, RENDERING METHOD, AND DECODING METHOD

(71) Applicant: GUANGDONG OPPO MOBILE TELECOMMUNICATIONS CORP., LTD., Dongguan (CN)

(72) Inventors: You YANG, Dongguan (CN); Yongquan SU, Dongguan (CN); Qiong LIU, Dongguan (CN); Kejun WU, Dongguan (CN)

(21) Appl. No.: 18/508,689

(22) Filed: Nov. 14, 2023

Related U.S. Application Data
(63) Continuation of application No. PCT/CN2021/093952, filed on May 14, 2021.

(51) Int. Cl. G06T 11/00; G06T 7/11; G06T 9/00

(52) U.S. Cl. CPC G06T 11/001; G06T 7/11; G06T 9/00; G06T 2207/20021

(57) ABSTRACT

A virtual view drawing method, a rendering method and apparatus, and a decoding method are provided. A first visibility map and a first texture map of a target view are generated. Region segmentation is performed on the first texture map to obtain a region segmentation result. A parameter representing segmentation performance is determined according to the region segmentation result. Region re-segmentation is performed on the first texture map when the parameter representing segmentation performance does not satisfy a first condition, to obtain a final region segmentation of the first texture map. Pixels to-be-updated in a region in the first visibility map are updated according to the final region segmentation result of the first texture map, to obtain a second visibility map. The second visibility map is shaded to obtain a second texture map of the target view.

### CROSS-REFERENCE TO RELATED APPLICATION(S)

This application is a continuation of International Application No. PCT/CN2021/093952, filed May 14, 2021, the entire disclosure of which is incorporated herein by reference.

### TECHNICAL FIELD

The disclosure relates to the computer vision technology, including but not limited to a virtual view drawing method, a rendering method, and a decoding method.

### BACKGROUND

In virtual view drawing, due to factors like inaccurate depth estimation and compression distortion, noise regions and transition band regions may exist in a depth map of a target view, which leads to unqualified image quality of a final texture map.

### SUMMARY

In a first aspect, a virtual view drawing method provided in embodiments of the disclosure includes the following. A first visibility map and a first texture map of a target view are generated according to an atlas of a source view. A number of segmented regions is determined. Region segmentation is performed on the first texture map according to the number of segmented regions to obtain a region segmentation result. A parameter representing segmentation performance is determined according to the region segmentation result. Region re-segmentation is performed on the first texture map when the parameter representing segmentation performance does not satisfy a first condition, until a second condition is satisfied or the parameter representing segmentation performance satisfies the first condition, to obtain a final region segmentation result of the first texture map. The region re-segmentation includes: adjusting the number of segmented regions; performing segmentation on the first texture map according to the adjusted number of segmented regions, to obtain a new region segmentation result; and determining the parameter representing segmentation performance according to the new region segmentation result. Pixels to-be-updated in a region in the first visibility map corresponding to a segmented region in the first texture map are updated according to the final region segmentation result of the first texture map, to obtain a second visibility map. The second visibility map is shaded to obtain a second texture map of the target view.

In a second aspect, a rendering method provided in embodiments of the disclosure includes the following. The second texture map of the target view is obtained according to the virtual view drawing method provided in embodiments of the disclosure. A target viewpoint of the target view is generated according to the second texture map of the target view.

In a third aspect, a decoding method provided in embodiments of the disclosure includes the following. An input bitstream is decoded to obtain an atlas of a source view. The virtual view drawing method provided in embodiments of the disclosure is performed on the atlas of the source view to obtain the second texture map of the target view. A target viewpoint of the target view is generated according to the second texture map of the target view.

### BRIEF DESCRIPTION OF THE DRAWINGS

The accompanying drawings, which are incorporated in and constitute a part of the specification, illustrate embodiments of the disclosure, and together with the description, serve to explain the technical solutions of the disclosure.

FIG. 1 is a schematic diagram of a system architecture that may be applied in embodiments of the disclosure.

FIG. 2 is a schematic flowchart of a virtual view drawing method provided in embodiments of the disclosure.

FIG. 3 is a schematic flowchart of a virtual view drawing method provided in embodiments of the disclosure.

FIG. 4 is a schematic flowchart of a virtual view drawing method provided in embodiments of the disclosure.

FIG. 5 is a schematic diagram of accurate segmented regions and inaccurate segmented regions in embodiments of the disclosure.

FIG. 6 is a schematic flowchart of using superpixel segmentation on a texture map to optimize a depth map in view generation.

FIG. 7 is a schematic flowchart of a method of iteration-based adaptive selection on the number of superpixels provided in embodiments of the disclosure.

FIG. 8 is a schematic structural diagram of a virtual view drawing apparatus provided in embodiments of the disclosure.

FIG. 9 is a schematic structural diagram of a rendering apparatus provided in embodiments of the disclosure.

FIG. 10 is a schematic structural diagram of a decoding apparatus provided in embodiments of the disclosure.

FIG. 11 is a schematic diagram of a hardware entity of an electronic device provided in embodiments of the disclosure.

### DETAILED DESCRIPTION

In order to make purposes, technical solutions, and advantages of the disclosure clearer, the following will further describe in detail embodiments of the disclosure with reference to the accompanying drawings. Embodiments hereafter are for illustration of the disclosure and are not intended to limit the disclosure.

Unless otherwise defined, all technical and scientific terms used herein have the same meaning as commonly understood by those of skill in the art of the disclosure. The terms used herein in the disclosure are for the purpose of describing embodiments only and are not intended to limit the disclosure.

In the following description, “some embodiments” describe a sub-set of all possible embodiments, but it may be understood that “some embodiments” may be the same sub-set or different sub-sets of all possible embodiments and may be combined with one another without conflict.

It may be noted that the terms “first”, “second”, “third”, and the like used in embodiments of the disclosure are used to distinguish different objects rather than describe a particular order. It may be understood that “first”, “second”, “third”, and the like may be interchanged in a particular order or priority, so that embodiments of the disclosure described herein may be implemented in an order other than that illustrated or described herein.

System architectures and service scenarios described in embodiments of the disclosure are intended to illustrate the technical solutions of embodiments more clearly and do not constitute a limitation to the technical solutions of embodiments of the disclosure. The technical solutions in embodiments of this disclosure is applicable to various types of system architectures. It may be understood by those of ordinary skill in the art that the technical solutions of the embodiments of the disclosure are equally applicable to similar technical problems as the system architectures evolve and new service scenarios emerge.

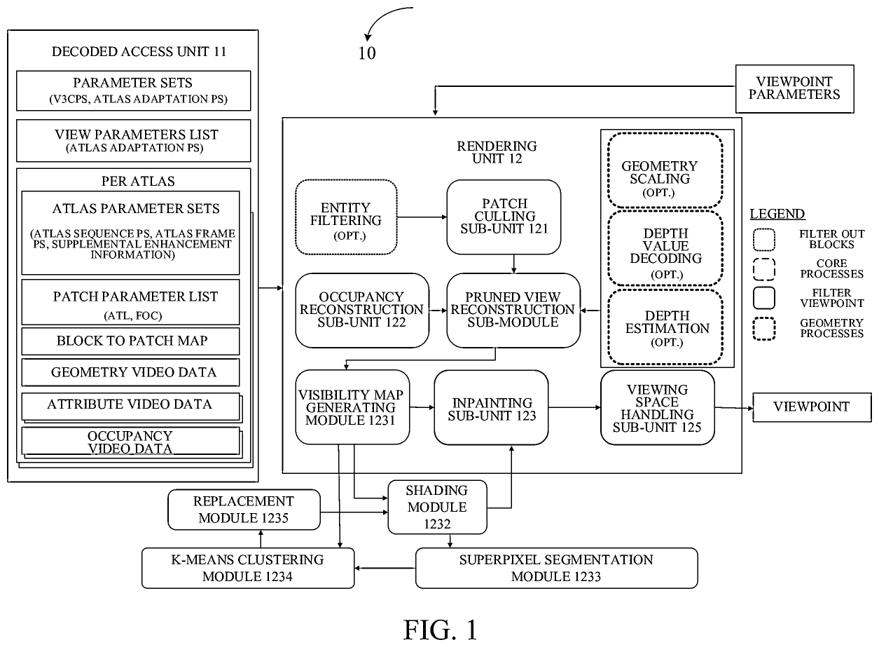

FIG. 1 illustrates a system architecture to which embodiments of the disclosure may apply, i.e. a system architecture 10 at the decoding end of the 3 degrees of freedom + (3DoF +) test model of immersive video (TMIV) provided in the moving picture experts group (MPEG). As illustrated in FIG. 1, the system architecture 10 includes a decoded access unit 11 and a rendering unit 12. The decoded access unit 11 includes various types of metadata and atlas information obtained after decoding. The information will be transmitted to the rendering unit 12 for virtual view drawing. Sub-units marked with opt. represent optional sub-units, which are not described herein because the sub-units are not mentioned in the technical solutions of embodiments of the disclosure. A patch culling sub-unit 121 of the rendering unit 12 filters patches in the atlas information according to target viewpoint parameters, and culls the patches that do not overlap with the target viewpoint, thereby reducing computation in the virtual view drawing. An occupancy reconstruction sub-unit 122 of the rendering unit 12 locates a position of each patch in the target viewpoint according to information transmitted from the decoded access unit 11, and then pastes the filtered patches into the corresponding positions to complete pruned view reconstruction, thereby obtaining a reconstructed depth map of the source view. A view weighting synthesizer (VWS) sub-unit is divided into two modules: a visibility map generating module 1231 and a shading module 1232. The visibility map generating module 1231 is configured to generate a visibility map of the target view according to the reconstructed depth map of the source view, and the shading module 1232 is configured to shade the visibility map generated in the visibility map generating module 1231, so as to generate a texture map of the target view.

In VWS, the depth map exists in a form of visibility map. The visibility map and the depth map have the same meaning, both representing a distance between the scene and the camera. Different from the depth map, in the visibility map, the closer to the camera, the smaller the pixel value. The texture map is an image representing scene texture, which is different from the depth map.

On this basis, as illustrated in FIG. 1, after the technical solution of using superpixel segmentation on a texture map to optimize a depth map in view generation is realized on the VWS, three new modules are introduced, which are a superpixel segmentation module 1233, a k-means clustering module 1234, and a replacement module 1235. The superpixel segmentation module 1233 uses a superpixel segmentation algorithm to segment a texture map generated by the VWS, and applies the segmentation result to a generated visibility map to obtain several superpixels on the visibility map. The k-means clustering module 1234 clusters each superpixel on the obtained visibility map with the k-means clustering algorithm, so that noise regions and transition band regions that need to be processed can be separated from regions that do not need to be processed. Then the replacement module 1235 replaces pixel values in the regions that need to be processed. In this way, the noise regions and transition band regions in the obtained depth map can be significantly reduced. The visibility map obtained after replacement is input to the shading module 1232. Since certain empty areas exist in the texture map of the target view generated by the shading module 1232, an inpainting sub-unit 124 needs to pad the empty areas to obtain a padded texture map. Finally, a viewing space handling sub-unit 125 may make the padded texture map smoothly faded to black to obtain a target viewpoint of the target view.

It may be noted that, the technical solution of using superpixel segmentation on texture map to optimize a depth map in view generation may be realized on a basis of the VWS of MPEG 3DoF+ TMIV6, and may also be realized on other types of virtual view drawing tools. The technical solution may be applied to various types of virtual view drawing tools.

The method provided in embodiments of the disclosure may be applied to any electronic device with data processing capability, which may be a device that equipped with video encoding and decoding function or a device equipped with only decoding function, such as a television, a projector, a mobile phone, a personal computer, a tablet computer, or a virtual reality (VR) headset. The function of the method may be realized by executing program codes through a processor in the electronic device, and the program codes may be stored in a computer storage medium. Therefore, the electronic device includes at least a processor and a storage medium.

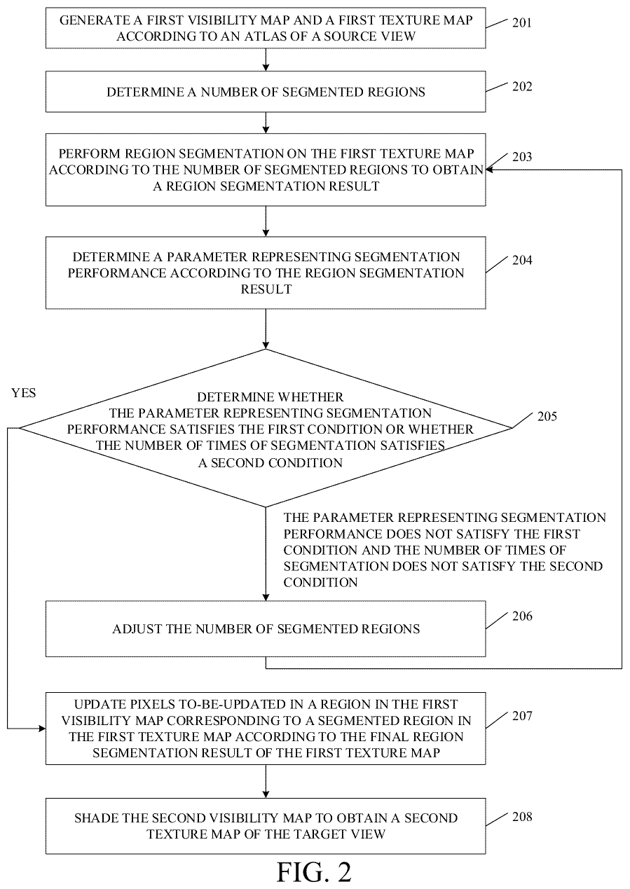

FIG. 2 is a schematic flowchart of a virtual view drawing method provided in embodiments of the disclosure. As illustrated in FIG. 2, the method may include the following operations 201 to 208.

At 201, a first visibility map and a first texture map of a target view are generated according to an atlas of a source view.

In some embodiments, an electronic device may decode an input bitstream to obtain an atlas of depth maps of the source view and an atlas of texture maps of the source view. Then, the electronic device may perform pruned view reconstruction on the atlas of depth maps of the source view to obtain reconstructed depth maps of the source view. The electronic device may generate the first visibility map of the target view according to the reconstructed depth maps. The electronic device may perform pruned view reconstruction on the atlas of texture maps of the source view to obtain reconstructed texture maps of the source view. According to the reconstructed texture maps, the electronic device may shade the first visibility map of the target view to obtain the first texture map.

In embodiments of the disclosure, the number of the source views is not limited. The electronic device may generate the first visibility map and the first texture map of the target view according to the atlas of one or more source views.

At 202, a number of segmented regions is determined.

The electronic device may obtain a preset number of segmented regions directly, or may obtain the number of segmented regions by calculation according to the first texture map. For example, the number of segmented regions may be determined through operations 302 and 303 in the following embodiment.

At 203, region segmentation is performed on the first texture map according to the number of segmented regions to obtain a region segmentation result.

In some embodiments, using a superpixel segmentation algorithm, the electronic device may perform superpixel segmentation on the first texture map according to the number of segmented regions (i.e., the number of superpixels), so as to obtain multiple superpixels (i.e., an example of segmented regions), where one superpixel represents one segmented region. It may be understood that the superpixel refers to an irregular pixel block with certain visual significance that is composed of adjacent pixels with similar characteristics such as texture, color, and brightness.

In the embodiments of the disclosure, a variety of superpixel segmentation algorithms may be used, which are not limited in the embodiments of the disclosure. For example, the superpixel segmentation algorithm may be a simple linear iterative cluster (SLIC) superpixel segmentation algorithm, a superpixel extracted via energy-driven sampling (SEEDS) algorithm, a contour-relaxed superpixels (CRS) algorithm, an ETPS, or an entropy rate superpixel segmentation (ERS) algorithm, etc.

At 204, a parameter representing segmentation performance is determined according to the region segmentation result.

In some embodiments, the parameter representing segmentation performance includes a segmentation accuracy and/or an average number of pixels of the segmented regions. The meaning of the segmentation accuracy is not limited. The segmentation accuracy may refer to the proportion of the number of accurate segmented regions in the region segmentation result. Correspondingly, in some embodiments, a first condition is that the segmentation accuracy is greater than a threshold, or the first condition is that the average number of pixels of the segmented regions is less than or equal to a fourth threshold. The segmentation accuracy may also refer to the proportion of the number of inaccurate segmented regions in the region segmentation result. Correspondingly, in some embodiments, the first condition is that the segmentation accuracy is less than a third threshold, or the average number of pixels of segmented regions is less than or equal to the fourth threshold.

In some embodiments, when the parameter representing segmentation performance refers to the average number of pixels, the first condition may be that the average number of pixels is less than or equal to the fourth threshold.

At 205, whether the parameter representing segmentation performance satisfies the first condition or whether the number of times of segmentation satisfies a second condition is determined. If the parameter representing segmentation performance does not satisfy the first condition and the number of times of segmentation does not satisfy the second condition, operation 206 is implemented. If the parameter representing segmentation performance satisfies the first condition or the number of times of segmentation satisfies the second condition, operation 207 is implemented.

It may be understood that, the second condition is a reserved early-exit condition. For example, after a certain times of segmentation, if the parameter representing segmentation performance still does not satisfy the first condition, the segmentation will not continue, in the purpose of reducing complexity of processing.

At 206, the number of segmented regions is adjusted, and then return to operation 203.

That is, if the parameter representing segmentation performance does not satisfy the first condition and the number of times of segmentation does not satisfy the second condition, re-segmentation is performed on the first texture map until the number of times of segmentation satisfies the second condition or the parameter representing segmentation performance satisfies the first condition, so as to obtain the final region segmentation result of the first texture map. The re-segmentation includes: adjusting the number of segmented regions; performing segmentation on the first texture map according to the adjusted number of segmented regions to obtain a new region segmentation result; and determining the parameter representing segmentation performance according to the new region segmentation result.

In the embodiments of the disclosure, a step-size for adjusting the number of segmented regions may be any value, which is not limited here. For example, the number of segmented regions before adjustment is 2000, and the number of segmented regions after adjustment is 2500, that is, the step-size for each adjustment is 500. For another example, the number of segmented regions before adjustment is 2000, and the number of segmented regions after adjustment is 1000, that is, the step-size for adjustment is 1000.

At 207, pixels to-be-updated in a region in the first visibility map corresponding to a segmented region in the first texture map are updated according to the final region segmentation result of the first texture map, to obtain a second visibility map.

In some embodiments, with the final region segmentation result of the first texture map as a region segmentation result of the first visibility map, pixels in a segmented region in the first visibility map are classified to obtain first-type pixels and second-type pixels. Then, pixels to-be-updated in the segmented region in first visibility map are determined according to a relationship between the number of first-type pixels and the number of second-type pixels and a relationship between a pixel-value representative of first-type pixels and a pixel-value representative of second-type pixels (such as mean value or mid-value).

In some embodiments, pixel values of the pixels to-be-updated in segmented regions in the first visibility map may be updated, so as to obtain the second visibility map.

The pixel values of the pixels to-be-updated may be updated in various manners. For example, the electronic device may filter the pixel values of the pixels to-be-updated in the first visibility map to update the pixel values. For another example, the electronic device may also replace the pixel values of the pixels to-be-updated with pixel-value replacements to update the pixel values. Each segmented region corresponds to a pixel-value replacement, and the pixel-value replacement may be a mean value of pixel values of pixels other than the pixels to-be-updated (also referred to as non-updating pixels) in the corresponding segmented region. In the case of using a clustering algorithm, each segmented region corresponds to a cluster center of a pixel class of non-updating pixels, and therefore a pixel value of the cluster center may be used as the pixel-value replacement.

At 208, the second visibility map is shaded to obtain a second texture map of the target view.

In the embodiments of the disclosure, after region segmentation on the first texture map according to the number of segmented regions, whether the parameter representing segmentation performance of the region segmentation result satisfies the first condition is first determined, instead of directly performing quality improvement on the first visibility map with the obtained region segmentation result. If the first condition is not satisfied, re-segmentation is performed until the second condition is satisfied or the parameter representing segmentation performance satisfies the first condition, and then quality improvement is performed on the first visibility map with the final region segmentation result of the first texture map (i.e., operation 207). As such, on one hand, noise regions and transition band regions in the first visibility map can be well eliminated, so as to obtain the second visibility map with better quality, and then obtain the second texture map that satisfies the quality requirements. On the other hand, since the number of segmented regions may be adaptively adjusted, a better region segmentation result can be obtained. Since there is no need for a user to directly give a suitable number of segmented regions, the bar for using the method can be lowered and the requirements of related knowledge for the user can be reduced.

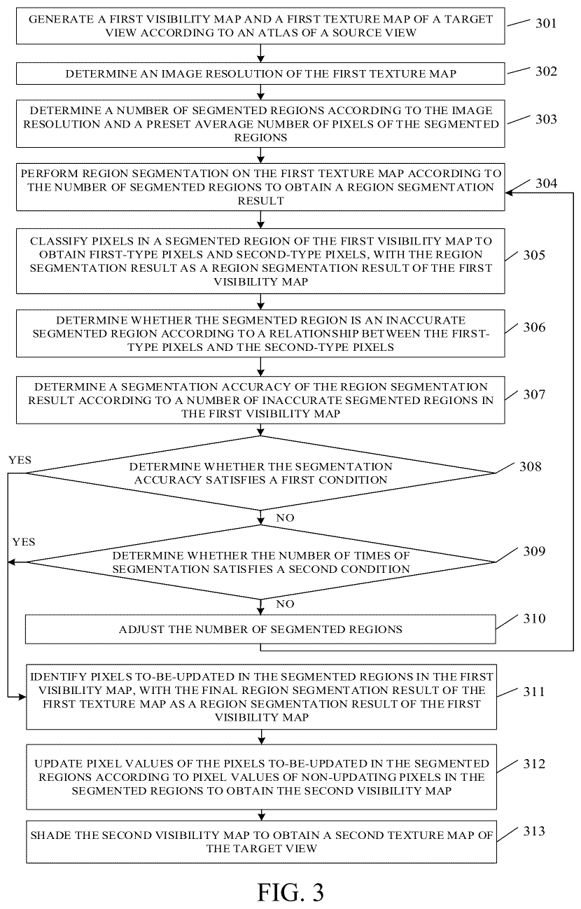

Another virtual view drawing method is provided in embodiments of the disclosure. FIG. 3 is a schematic flowchart of a virtual view drawing method provided in embodiments of the disclosure. As illustrated in FIG. 3, the method may include the following operations 301 to 313.

At 301, a first visibility map and a first texture map of a target view are generated according to an atlas of a source view.

At 302, an image resolution of the first texture map is determined.

At 303, a number of segmented regions is determined according to the image resolution and a preset average number of pixels of the segmented regions.

In some embodiments, an electronic device may calculate the number of segmented regions init_numSuperpixel according to the following formula (1) or formula (2).

init_numSuperpixel=round (width*height/M) (1)

init_numSuperpixel=round (width*height/M/100)*100 (2)

In the above, width represents the width of the image, height represents the height of the image, round represents rounding, and M represents the preset average number of pixels of the segmented regions (for example, the number is 2000), and the calculated init_numSuperpixel has an accuracy of 100. In some embodiments, M is generally set to a maximum value, such that the initially-set number of segmented regions is a minimum value.

It may be understood that, the electronic device may adaptively determine the number of segmented regions according to the image revolution of the first texture map. Since the number of segmented regions does not need to be set in advance, the bar for using the virtual view drawing method provided in the embodiment of the disclosure may be lowered.

At 304, region segmentation is performed on the first texture map according to the number of segmented regions to obtain a region segmentation result.

At 305, with the region segmentation result as a region segmentation result of the first visibility map, pixels in a segmented region in the first visibility map are classified to obtain first-type pixels and second-type pixels.

It may be understood that, scene contents conveyed at same positions in the first visibility map and the first texture map convey are consistent. Therefore, the electronic device may directly apply the region segmentation result of the first texture map on the first visibility map, and the region segmentation result of the first texture map is the region segmentation result of the first visibility map.

The electronic device may classify the pixels of each segmented region in the first visibility map, for example, classifying the pixels of each segmented region into two types. Various classification algorithms may be used. For example, the classification algorithms may include k-means clustering, decision tree, bayesian classifier, artificial neural network, support vector machine, or classification based on association rules.

At 306, whether the segmented region is an inaccurate segmented region is determined according to a relationship between the first-type pixels and the second-type pixels.

In some embodiments, the electronic device may implement operation 306 according to operations 405 to 407 in the following embodiment.

At 307, a segmentation accuracy of the region segmentation result is determined according to a number of inaccurate segmented regions in the first visibility map.

In some embodiments, the segmentation accuracy may be the proportion of the number of inaccurate segmented regions in the region segmentation result. For example, the proportion is obtained by dividing the number of inaccurate segmented regions by the number of accurate segmented regions, or the proportion is obtained by dividing the number of inaccurate segmented regions by the number of segmented regions obtained in operation 303, or the proportion is obtained by dividing the number of inaccurate segmented regions by the total number of segmented regions in the region segmentation result.

In other embodiments, the segmentation accuracy may also be the proportion of the number of accurate segmented regions in the region segmentation result. For example, the proportion is obtained by dividing the number of accurate segmented regions by the number of segmented regions obtained in operation 303, or the proportion is obtained by dividing the number of accurate segmented regions by the total number of segmented regions in the region segmentation result.

At 308, whether the segmentation accuracy satisfies a first condition is determined. If the segmentation accuracy satisfies the first condition, operation 311 is implemented; otherwise, operation 309 is implemented.

At 309, whether the number of times of segmentation satisfies a second condition is determined. If the number of times of segmentation satisfies the second condition, operation 311 is implemented; otherwise, operation 310 is implemented.

At 310, the number of segmented regions is adjusted, and then return to operation 304.

That is, if the segmentation accuracy does not satisfy the first condition, and the number of times of segmentation does not satisfy the second condition, then the number of segmented regions is adjusted. The first texture map is then re-segmented according to the adjusted number of segmented regions, until a segmentation accuracy of an obtained region segmentation result satisfies the first condition, or the number of times of segmentation satisfies the second condition. Then operation 311 is implemented.

At 311, pixels to-be-updated in the segmented regions in the first visibility map are identified, with the final region segmentation result of the first texture map as a region segmentation result of the first visibility map.

At 312, pixel values of the pixels to-be-updated in the segmented regions are updated according to pixel values of non-updating pixels in the segmented regions, to obtain the second visibility map.

The non-updating pixels refer to pixels other than the pixels to-be-updated in the segmented regions. For example, pixels in the segmented region are classified into the first-type pixels and the second-type pixels. If the first-type pixels are the pixels to-be-updated, the second-type pixels are the non-updating pixels.

The pixel values of the pixels to-be-updated may be updated in various manners. For example, the electronic device may filter pixel values of the pixels to-be-updated, and may also replace pixel values of the pixels to-be-updated in the segmented region with pixel-value replacements in the segmented region. In some embodiments, pixel values of the pixels to-be-updated in the segmented region may be replaced with representative pixel values of pixels other than the pixels to-be-updated in the segmented region such as mean value or mid-value.

At 313, the second visibility map is shaded to obtain a second texture map of the target view.

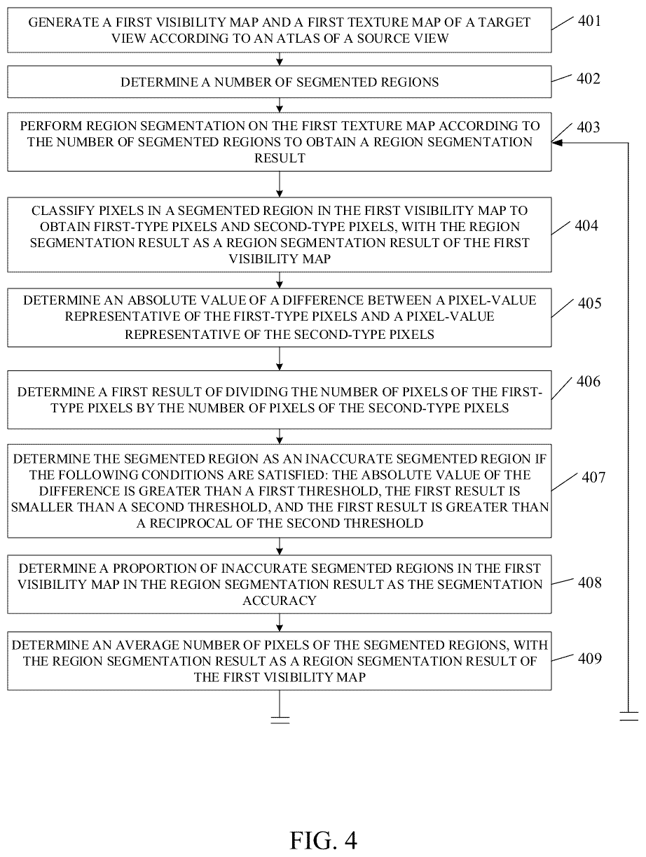

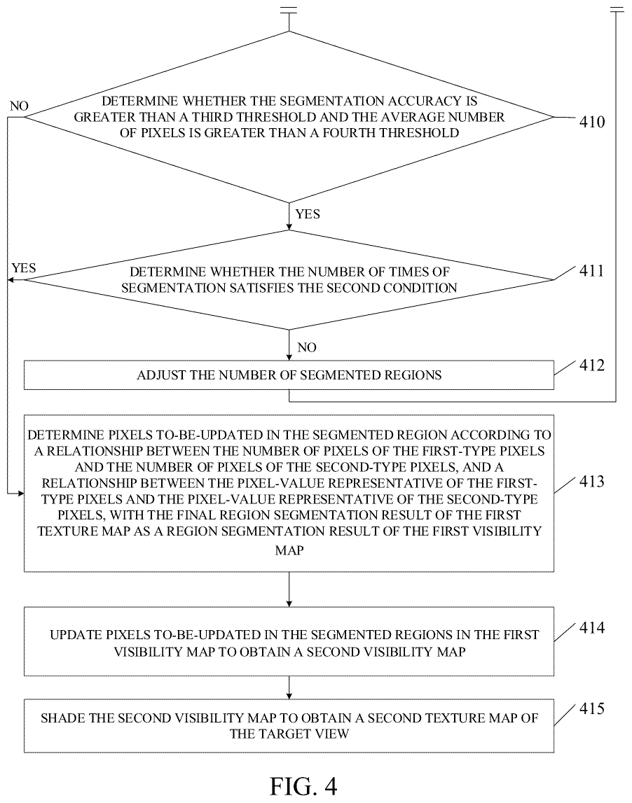

Another virtual view drawing method is provided in embodiments of the disclosure. FIG. 4 is a schematic flowchart of a virtual view drawing method provided in embodiments of the disclosure. As illustrated in FIG. 4, the method may include the following operations 401 to 415.

At 401, a first visibility map and a first texture map of a target view are generated according to an atlas of a source view.

At 402, a number of segmented regions is determined.

At 403, region segmentation is performed on the first texture map according to the number of segmented regions to obtain a region segmentation result.

At 404, with the region segmentation result as a region segmentation result of the first visibility map, pixels in a segmented region in the first visibility map are classified to obtain first-type pixels and second-type pixels.

At 405, an absolute value of a difference between a pixel-value representative of the first-type pixels and a pixel-value representative of the second-type pixels is determined.

The pixel-value representative refers to a representative pixel value in the first-type pixels, the representative pixel value may be a mean value or mid-value of pixel values of the first-type pixels in the segmented region.

At 406, a first result of dividing the number of pixels of the first-type pixels by the number of pixels of the second-type pixels is determined.

At 407, the segmented region is determined as an inaccurate segmented region if the following conditions are satisfied: the absolute value of the difference is greater than a first threshold, the first result is smaller than a second threshold, and the first result is greater than a reciprocal of the second threshold.

In the embodiments of the disclosure, the values of the first threshold and the second threshold are not limited. These thresholds may be set according to a performance index of practical application. In some embodiments, the first threshold is in a range of [25, 33], and the second threshold is in a range of [5, 10]. For example, the first threshold is 30 and the second threshold is 5.

It may be understood that, an ideal region segmentation is a segmentation along the edge of the foreground, that is to say, each segmented region may well separate the foreground from the background. A so-called unsatisfactory region segmentation refers to a segmentation with both foreground and background contents in a segmented region, and the segmented region includes foreground and background. In a depth map, the color of the foreground is close to white and the color of the background is close to black, which means that pixel values of the foreground are greatly different from pixel values of the background. In this case, when identifying the pixels to-be-updated, the foreground or background may be misjudged as the pixels to-be-updated, which leads to poor optimization result. If two types of pixels in a segmented region have great difference in average pixel values and little difference in the number of pixels, the segmented region is considered as an inaccurate segmented region, and the segmented region is likely to include foreground and background.

When the first visibility map is optimized based on the region segmentation result, in the accurate segmented region, one type of pixels has a small proportion, a ratio of the type of pixels to another type of pixels in terms of the number of pixels is less than a threshold, and the difference in pixel values between the two types of pixels is greater than a threshold. For example, as illustrated in FIG. 5, segmented regions 51, 52, 53 and 54 are accurate segmented regions, that is, one type of pixels and another types of pixels in the segmented regions have great difference in the number of pixels and have great difference in pixel values. Situations may be as illustrated in regions 51 to 54. In region 51, a type of pixels with less number of pixels are foreground pixels (i.e. pixels to-be-updated), and a type of pixels with more number of pixels are background pixels. In region 52, a type of pixels with less number of pixels are background pixels (i.e. pixels to-be-updated), and a type of pixels with more number of pixels are foreground pixels. In region 53, a type of pixels with less number of pixels are noise pixels (i.e. pixels to-be-updated), and a type of pixels with more number of pixels are background pixels. In region 54, a type of pixels with less number of pixels are noise pixels (i.e. pixels to-be-updated), and a type of pixels with more number of pixels are foreground pixels. According to this, after updating pixels to-be-updated in regions such as region 51 and region 52, the edges of the finally obtained second texture map may be more sharpened and steeper, and after updating pixels to-be-updated in regions such as regions 53 and region 54, the finally obtained second texture map may have less noise regions.

In some situations, region 55 and region 56 may be inaccurate segmented regions. As illustrated in FIG. 5, in both region 55 and region 56, two types of pixels have great difference in pixel values, i.e. the absolute value of the difference is greater than the first threshold, but two types of pixels have similar number of pixels, i.e. the first result is smaller than the second threshold and the first result is greater than the reciprocal of the second threshold, which means these regions include both foreground and background. If a certain type of pixels in these regions are updated, an error may occur, meaning that noise regions cannot be eliminated and edges cannot be sharpened. Therefore, these inaccurate segmented regions are adverse to obtain a second texture map with more sharpened edges and less noise regions.

At 408, a proportion of inaccurate segmented regions in the first visibility map in the region segmentation result is determined as the segmentation accuracy.

The proportion may be obtained by dividing the number of inaccurate segmented regions by the number of accurate segmented regions, or may be obtained by dividing the number of inaccurate segmented regions by the number of segmented regions obtained in operation 402, or obtained by dividing the number of inaccurate segmented regions by the total number of segmented regions in the region segmentation result.

At 409, an average number of pixels of the segmented regions is determined, with the region segmentation result as a region segmentation result of the first visibility map.

At 410, whether the segmentation accuracy is greater than a third threshold and the average number of pixels is greater than a fourth threshold are determined. If the segmentation accuracy is greater than the third threshold and the average number of pixels is greater than the fourth threshold, operation 411 is implemented; otherwise, operation 413 is implemented.

That is, if the segmentation accuracy is greater than the third threshold and the average number of pixels is greater than the fourth threshold, the parameter representing segmentation performance of the region segmentation result does not satisfy the first condition. If the segmentation accuracy is less than or equal to the third threshold, or the average number of pixels is less than or equal to the fourth threshold, the parameter representing segmentation performance of the region segmentation result satisfies the first condition, and then iteration is ended and operation 413 is implemented.

If the average number of pixels reaches a certain accuracy (for example, 500), even if the first texture map is re-segmented by adjusting the number of segmented regions, the quality of the finally obtained second texture map may not be obviously improved. That is, when the average number of pixels reaches a certain accuracy, the obtained second texture map becomes convergent. Therefore, when determining whether the current region segmentation result is the final region segmentation result, both the segmentation accuracy and the average number of pixels are considered, so that the iteration can be ended as soon as possible on the premise of ensuring the image quality of the second texture map, thereby saving the calculation time and improving the real-time performance of virtual view drawing.

In some embodiments, the average number of pixels may not be considered. That is, if the segmentation accuracy is greater than the third threshold, the parameter representing segmentation performance of the region segmentation result is determined to not satisfy the first condition; otherwise, the parameter representing segmentation performance of the region segmentation result is determined to satisfy the first condition.

At 411, whether the number of times of segmentation satisfies the second condition is determined. If the number of times of segmentation satisfies the second condition, operation 413 is implemented; otherwise, operation 412 is implemented.

At 412, the number of segmented regions is adjusted, then return to operation 403.

That is, if the parameter representing segmentation performance does not satisfy the first condition, the first texture map is re-segmented according to the adjusted number of segmented regions, and operations 404 to 411 are implemented again until the number of times of segmentation satisfies the second condition or the parameter representing segmentation performance of the region segmentation result satisfies the first condition, and then operation 413 is implemented.

At 413, with the final region segmentation result of the first texture map as a region segmentation result of the first visibility map, pixels to-be-updated in the segmented region are determined according to a relationship between the number of pixels of the first-type pixels and the number of pixels of the second-type pixels, and a relationship between the pixel-value representative of the first-type pixels and the pixel-value representative of the second-type pixels.

It may be understood that classification is performed for each segmented region in the first visibility map when implementing operation 404, so that the calculation result of operation 404 may be directly used in operation 413 without performing classification again.

In some embodiments, the second-type pixels are determined as pixels to-be-updated in the segmented region when a second result of subtracting the pixel-value representative of the second-type pixels from the pixel-value representative of the first-type pixels is greater than or equal to a fifth threshold, and when a first result of dividing the number of the first-type pixels by the number of the second-type pixels is greater than or equal to a sixth threshold. The first-type pixels are determined as pixels to-be-updated in the segmented region when a third result of subtracting the pixel-value representative of the first-type pixels from the pixel-value representative of the second-type pixels is greater than or equal to the fifth threshold, and when a fourth result of dividing the number of the second-type pixels by the number of the first-type pixels is greater than or equal to the sixth threshold.

It may be noted that the fifth threshold may be the same as or different from the first threshold mentioned above, and the fifth threshold may be larger or smaller than the first threshold. The sixth threshold may be set to be equal to or not equal to the second threshold mentioned above, and the sixth threshold may be greater than or less than the second threshold. For example, the first threshold and the fifth threshold may both in a range of [25, 33], and the second threshold and the sixth threshold may both in a range of [5, 10].

It may be understood that, by determining pixels to-be-updated in the segmented regions through the above method, pixels to-be-updated in regions such as region 51, region 52, region 53, and region 54 illustrated in FIG. 5 may be updated. On one hand, the edges in the finally obtained second texture map may be more sharpened and steeper; on the other hand, noise regions in the second texture map may be reduced. To sum up, image quality of the second texture map may be better.

At 414, pixels to-be-updated in the segmented regions in the first visibility map are updated to obtain a second visibility map.

At 415, the second visibility map is shaded to obtain a second texture map of the target view.

In some embodiments, the electronic device may take the final region segmentation result of the first texture map as a region segmentation result of each of first visibility maps of adjacent N frames, where N is greater than 0. That is to say, region segmentation results of the first visibility maps are the same for every consecutive N+1 frames. It may be understood that, image contents of adjacent frames are highly similar, so that first visibility maps of consecutive N+1 frames may share the final region segmentation result of the first texture map without calculating a final region segmentation result of the first texture map for each frame, thereby saving computation on the premise of ensuring image quality of each second texture map.

In some embodiments, the final region segmentation result of the first texture map is taken as region segmentation results of first visibility maps of the next frame to the next N-th frame, where N is greater than 1. A final region segmentation result of a first texture map of the next (N+1)-th frame is re-determined, which is taken as region segmentation results of first visibility maps of the subsequent adjacent N frames.

A rendering method is provided in embodiments of the disclosure. The method may be applied to an electronic device or a rendering apparatus. The method includes the following. Operations in the virtual view drawing method provided in the embodiment of the disclosure are first implemented to obtain a second texture map of a target view. Then a target viewpoint of the target view is generated according to the second texture map of the target view.

The above description of the embodiment of the rendering method is similar to the above description of the embodiments of the virtual view drawing methods, and has similar beneficial effects as the embodiment of the above virtual view drawing methods. Technical details not disclosed in the embodiment of the rendering method are understood with reference to the description of the embodiments of the above virtual view drawing methods.

A decoding method provided in embodiments of the disclosure includes the following. An input bitstream is decoded to obtain an atlas of a source view. Operations in the above virtual view drawing method are performed on the atlas of the source view to obtain a second texture map of a target view. A target viewpoint of the target view is generated according to the second texture map of the target view.

In the decoding method, since noise regions and/or transition band regions in the finally obtained target viewpoint can be greatly reduced, the encoding end can use larger quantization parameters to compress and encode the depth map on the basis of ensuring the image quality of the target viewpoint, thereby reducing the cost of encoding depth maps and further improving the overall encoding efficiency.

The above description of the embodiment of the decoding method is similar to the description of the embodiment of the above virtual view drawing method, and has similar beneficial effects as the embodiment of the above virtual view drawing method. Technical details not disclosed in the embodiment of the decoding method are understood with reference to the description of the embodiment of the above virtual view drawing method.

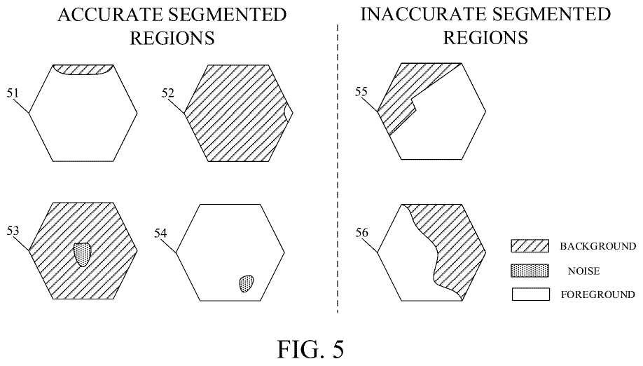

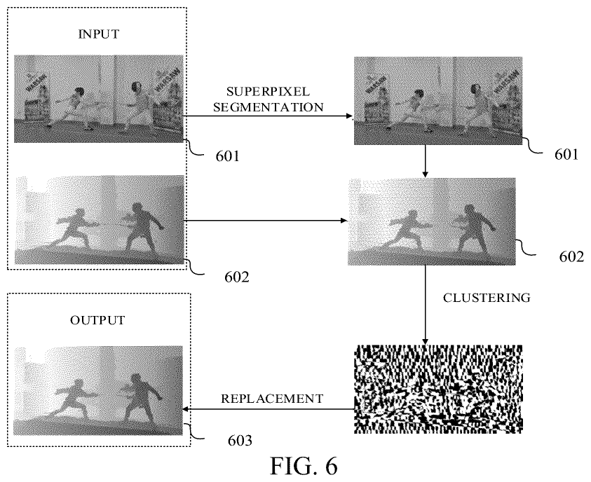

Due to factors like inaccurate depth estimation and compression distortion, noise regions and transition band regions may exist in the generated depth map of the target view. Therefore, a technical solution of using superpixel segmentation on the texture map to optimize a depth map in view generation is provided. The flowchart is illustrated in FIG. 6. The superpixel segmentation is first performed on a texture map 601, and then a superpixel region segmentation result obtained from the texture map 601 is applied to a depth map 602 to obtain several superpixels on the depth map 602. For each superpixel, the noise regions and transition band regions are extracted by clustering, and then replacement is made to these regions with appropriate values. Thereafter noise regions and transition band regions in the obtained depth map 603 can be greatly reduced.

The actual effect of the above technical solution of using superpixel segmentation on the texture map to optimize a depth map in view generation is closely related to the number of superpixels (numSuperpixel). The parameter numSuperpixel represents the number of superpixels defined by a user for superpixel segmentation on the texture map, which may affect the effect of superpixel segmentation, and then affect the effect of depth map optimization. When the numSuperpixel is too small, segmentation may not be proceeded well along the edge of the object, and when the numSuperpixel is too large, complexity of processing may increase. The above technical solution of depth map optimization does not provide a setting method of numSuperpixel, so the user needs to determine the size of numSuperpixel, which puts forward requirements for the relevant knowledge level of the user and raises the bar of using the technical solution.

Therefore, an exemplary application of the embodiment of the disclosure in a practical application scenario will be described in the following.

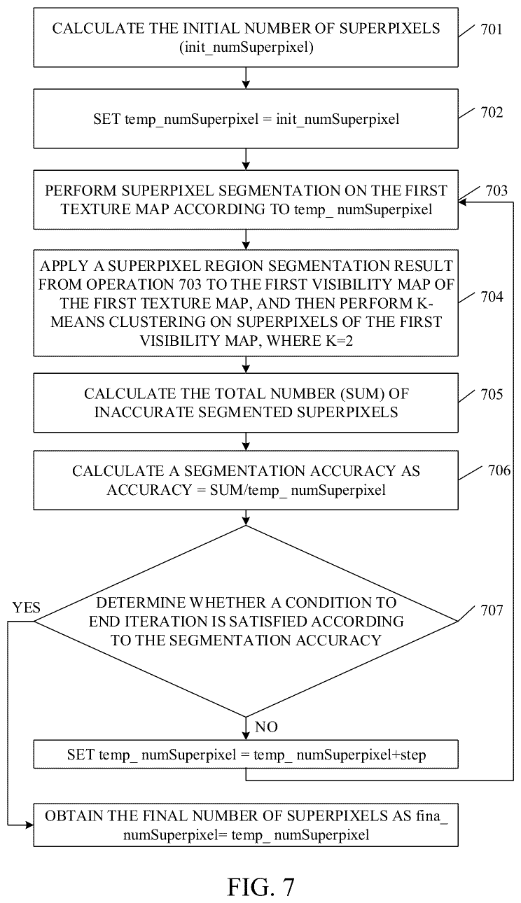

In embodiments of the disclosure, a method of adaptive selection on the number of superpixels based on iteration is provided. The flowchart of the method is illustrated in FIG. 7, including the following operations 701 to 707.

At 701, the initial number of superpixels (init_numSuperpixel) is calculated.

In some embodiments, init_numSuperpixel may be obtained according to an image resolution, as illustrated in formula (3).

init_numSuperpixel=round (width*height/2000/100)*100 (3).

In the above, width represents the width of the image, height represents the height of the image, round represents rounding, and the accuracy of init_numSuperpixel obtained by calculation is 100.

At 702, set temp_numSuperpixel=init_numSuperpixel.

At 703, superpixel segmentation is performed on the first texture map according to temp_numSuperpixel.

At 704, a superpixel region segmentation result from operation 703 is applied to the first visibility map of the first texture map, and then k-means clustering is performed on superpixels of the first visibility map, where k=2.

At 705, the total number (sum) of inaccurate segmented superpixels is calculated.

In some embodiments, an inaccurate segmented superpixel is determined as follows. After k-means clustering, each superpixel is divided into two parts. Assuming that cluster centers and the number of pixels in the two parts are center0, center1, sum0, and sum1, respectively, then the superpixel may be determined as an inaccurate segmented superpixel when conditions in the following formula (4) are satisfied.

(|center0−center1|>thresholdcen) and (sum0/sum1<thresholdsum) and (sum0/sum1>1/thresholdsum) (4).

In the above, thresholdcen and thresholdsum are two thresholds, where thresholdcen is usually equal to 30 and thresholdsum is usually equal to 5 according to former practices.

At 706, a segmentation accuracy is calculated as accuracy=sum/temp_numSuperpixel.

At 707, whether a condition to end iteration is satisfied is determined according to the segmentation accuracy. If the condition is satisfied, the final number of superpixels is obtained as fina_numSuperpixel=temp_numSuperpixel; otherwise, set temp_numSuperpixel=temp_numSuperpixel+step, then operation 703 is implemented.

In some embodiments, there are two conditions to end iteration. First, the segmentation accuracy satisfies a required accuracy, that is, accuracy<=thresholdaccu, where thresholdaccu may be slightly adjusted according to the accuracy requirement, and a recommended setting is 0.025. Second, the average number of pixels per superpixel is less than 500, that is, width*height/temp_numSuperpixel<500. Iteration may be ended if one of the two conditions is satisfied. If neither of the two conditions is satisfied, operation 703 is implemented after increasing the number of superpixels by a parameter step. The size of the parameter step affects the convergence speed of the method, and the parameter step is recommended to set as 500.

Considering the similarity of image contents in adjacent frames and the difference of image contents between frames with large intervals, a fixed period may be set in this solution, and the above adaptive algorithm for the number of superpixels is implemented for frames in every fixed period to update the number of superpixels.

The above method is tested on MPEG-I CTC test sequence, and the experimental results are illustrated in Table 1.

TABLE 1
Experimental results

| | Range of appropriate | Number of superpixels |
|---|---|---|
| Test sequence | number of superpixels | obtained in the present method |
| Frog | 800+ | 1000 |
| Fencing | 2000+ | 3000 |
| Street | 2500+ | 2500 |
| Painter | 3000+ | 4100 |

According to the experimental results, the method provided in the embodiments of the disclosure may adaptively track down a more appropriate number of superpixels, realizing the self-adaptation of the number of superpixels, and lowering the bar for using superpixel segmentation on the texture map to optimize a depth map in view generation.

Based on the aforementioned embodiments, modules and units included therein included in a virtual view drawing apparatus provided in embodiments of the disclosure may be realized by a processor, or by a specific logic circuit. In practical implementation, the processor may be a central processing unit (CPU), a microprocessor unit (MPU), a digital signal processor (DSP), a field programmable gate array (FPGA), etc.

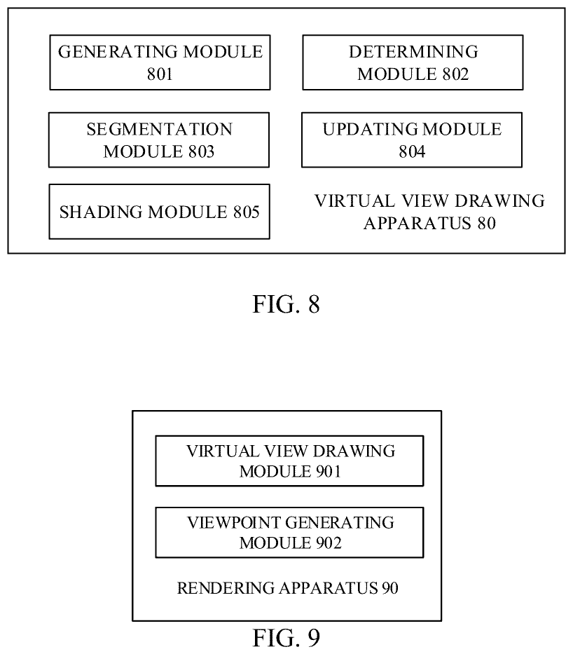

FIG. 8 is a schematic structural diagram of a virtual view drawing apparatus provided in embodiments of the disclosure. As illustrated in FIG. 8, the virtual view drawing apparatus 80 includes a generating module 801, a determining module 802, a segmentation module 803, an updating module 804, and a shading module 805.

The generating module 801 is configured to generate a first visibility map and a first texture map of a target view according to an atlas of a source view.

The determining module 802 is configured to determine a number of segmented regions.

The segmentation module 803 is configured to perform region segmentation on the first texture map according to the number of segmented regions to obtain a region segmentation result; determine a parameter representing segmentation performance according to the region segmentation result; and perform region re-segmentation on the first texture map when the parameter representing segmentation performance does not satisfy a first condition, until a second condition is satisfied or the segmentation accuracy satisfies the first condition, to obtain a final region segmentation result of the first texture map. The region re-segmentation includes: adjusting the number of segmented regions; performing segmentation on the first texture map according to the adjusted number of segmented regions, to obtain a new region segmentation result; and determining the parameter representing segmentation performance according to the new region segmentation result.

The updating module 804 is configured to update pixels to-be-updated in a region in the first visibility map corresponding to a segmented region in the first texture map according to the final region segmentation result of the first texture map, to obtain a second visibility map.

The shading module 805 is configured to shade the second visibility map to obtain a second texture map of the target view.

In some embodiments, the determining module 802 is configured to determine an image resolution of the first texture map, and determine the number of segmented regions according to the image resolution and a preset average number of pixels of the segmented regions.

In some embodiments, the parameter representing segmentation performance includes a segmentation accuracy of the region segmentation result. The segmentation module 803 is configured to classify pixels in a segmented region in the first visibility map with the region segmentation result as a region segmentation result of the first visibility map, to obtain first-type pixels and second-type pixels; determine whether the segmented region is an inaccurate segmented region according to a relationship between the first-type pixels and the second-type pixels; and determine the segmentation accuracy according to a number of inaccurate segmented regions in the first visibility map.

Further, in some embodiments, the segmentation module 803 is configured to determine an absolute value of a difference between a pixel-value representative of the first-type pixels and a pixel-value representative of the second-type pixels; determine a first result of dividing a number of the first-type pixels by a number of the second-type pixels; and determine the segmented region as the inaccurate segmented region when the following conditions are satisfied: the absolute value of the difference is greater than a first threshold, the first result is less than a second threshold, and the first result is greater than a reciprocal of the second threshold.

In some embodiments, the first threshold is in a range of [25, 33], and the second threshold is in a range of [5, 10].

In some embodiments, the parameter representing segmentation performance includes an average number of pixels of the segmented regions. The segmentation module 803 is configured to determine a proportion of inaccurate segmented regions in the region segmentation result as the segmentation accuracy; determine the average number of pixels with the region segmentation result as the region segmentation result of the first visibility map; determine that the parameter representing segmentation performance satisfies the first condition when the segmentation accuracy is less than or equal to a third threshold or the average number of pixels is less than or equal to a fourth threshold; and determine that the parameter representing segmentation performance does not satisfy the first condition when the segmentation accuracy is greater than the third threshold and the average number of pixels is greater than the fourth threshold.

In some embodiments, the segmentation module 803 is further configured to take the final region segmentation result of the first texture map as a region segmentation result of each of first visibility maps of adjacent N frames, where N is greater than 0.

In some embodiments, the updating module 804 is configured to obtain the number of the first-type pixels and the pixel-value representative of the first-type pixels; obtain the number of the second-type pixels and the pixel-value representative of the second-type pixels; and determine pixels to-be-updated in the segmented regions, according to a relationship between the number of the first-type pixels and the number of the second-type pixels, and a relationship between the pixel-value representative of the first-type pixels and the pixel-value representative of the second-type pixels.

Further, in some embodiments, the updating module 804 is configured to determine the second-type pixels as the pixels to-be-updated in the segmented regions when a second result of subtracting the pixel-value representative of the second-type pixels from the pixel-value representative of the first-type pixels is greater than or equal to a fifth threshold, and when a first result of dividing the number of the first-type pixels by the number of the second-type pixels is greater than or equal to a sixth threshold; and determine the first-type pixels as the pixels to-be-updated in the segmented regions when a third result of subtracting the pixel-value representative of the first-type pixels from the pixel-value representative of the second-type pixels is greater than or equal to the fifth threshold, and when the fourth result of dividing the number of the second-type pixels by the number of the first-type pixels is greater than or equal to the sixth threshold.

In some embodiments, the updating module 804 is configured to update pixel values of the pixels to-be-updated in the segmented region in the first visibility map according to pixel values of pixels other than the pixels to-be-updated in the segmented region in the first visibility map, to obtain the second visibility map.

A rendering apparatus is provided in embodiments of the disclosure. FIG. 9 is a schematic structural diagram of the rendering apparatus provided in embodiments of the disclosure. As illustrated in FIG. 9, the rendering apparatus 90 includes a virtual view drawing module 901 and a target viewpoint generating module 902.

The virtual view drawing module 901 is configured to obtain a second texture map of a target view according to operations in the virtual view drawing method provided in the embodiment of the disclosure.

The target viewpoint generating module 902 is configured to generate a target viewpoint of the target view according to the second texture map of the target view.

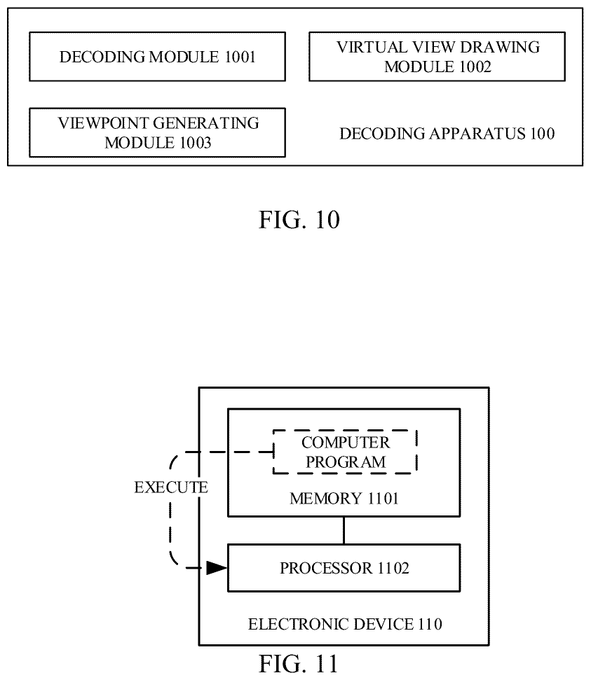

A decoding apparatus is provided in the embodiment of the disclosure. FIG. 10 is a schematic structural diagram of the decoding apparatus provided in the embodiment of the disclosure. As illustrated in FIG. 10, the decoding apparatus 100 includes a decoding module 1001, a virtual view drawing module 1002, and a target viewpoint generating module 1003.

The decoding module 1001 is configured to decode an input bitstream to obtain an atlas of a source view.

The virtual view drawing module 1002 is configured to implement operations in the virtual view drawing method provided in the embodiment of the disclosure on the atlas of the source view to obtain a second texture map of a target view.

The target viewpoint generating module 1003 is configured to generate the target viewpoint of the target view according to the second texture map of the target view.

The above description of apparatus embodiments is similar to the above description of method embodiments, and has similar beneficial effects as the method embodiments. Technical details not disclosed in the apparatus embodiments in the disclosure are understood with reference to the description of method embodiments in the disclosure.

It may be noted that, in embodiments of the disclosure, the above methods may be stored in a computer-readable storage medium if the above methods are implemented as software functional modules and sold or used as standalone products. Based on such understanding, the technical solution of the disclosure may be essentially embodied as software products, or a part of the technical solution of the disclosure that contributes to the prior art may be embodied as software products. The computer software products are stored in a storage medium and may include multiple instructions that, when executed, can cause a computing device to execute some or all operations in the methods described in embodiments of the disclosure. The storage mediums may include mediums that can store program codes, such as a universal serial bus (USB) flash disk, a mobile hard drive, a read-only memory (ROM), a magnetic disk, or an optical disk. Therefore, embodiments of the disclosure are not limited to combinations with any specific hardware or software.

Correspondingly, an electronic device is provided in the embodiments of the disclosure. FIG. 11 is a schematic diagram of a hardware entity of an electronic device provided in embodiments of the disclosure. As illustrated in FIG. 11, the electronic device 110 includes a memory 1101 and a processor 1102. The memory 1101 stores a computer program executable by the processor 1102, and the processor 1102 implements operations in methods provided in the above embodiments when executing the program.

It may be noted that the memory 1101 is configured to store instructions and applications executable by the processor 1102, and may also cache data (e.g. image data, audio data, voice communication data, and video communication data) to be processed or already processed by modules in the processor 1102 and the electronic device 110. This function of the memory 1101 may be realized by a flash memory (FLASH) or a random access memory (RAM).

Correspondingly, a computer-readable medium is provided in the embodiments of the disclosure. The computer-readable medium stores a computer program. Operations in methods provided in embodiments of the disclosure are implemented when the computer program is executed by a processor.

It may be noted that, the embodiments of storage medium and apparatus are similar to has similar beneficial effects as the method embodiments. Technical details not disclosed in the embodiments of medium and apparatus in the disclosure are understood with reference to the description of the method embodiments of the disclosure.

It may be understood that, terms “embodiment” or “the embodiment” or “some embodiments”, or “another embodiment” referred to herein mean that a particular feature, structure, material, or characteristic described in conjunction with the embodiment may be contained in at least one embodiment of the disclosure. Terms “in embodiment” or “in the embodiment” or “in some embodiments”, or “in another embodiment” appearing in various places in the specification do not necessarily refer to the same embodiment or implementation. The particular feature, structure, material, or characteristic described may be properly combined in any one or more embodiments. It may be understood that, in the above embodiments, a magnitude of a sequence number of each process does not mean an execution sequence, and the execution sequence of each process should be determined by its function and an internal logic and should not form any limit to an implementation process of embodiments of the disclosure. The above sequence number of embodiments are for description only and do not represent the advantages and disadvantages of embodiments.

It may be noted that, terms “include”, “comprise” as well as variations thereof are intended to cover non-exclusive inclusion, so that a process, method, object or device that includes a set of elements includes not only those elements, but also other elements that are not explicitly listed, or elements inherent to such a process, method, object or device. In the absence of further limitations, an element defined by the phrase “includes a . . . ” does not preclude the existence of another identical element in the process, method, object or device in which it is included.

It may be understood that the systems, apparatuses, and methods disclosed in embodiments herein may also be implemented in various other manners. The above embodiments are merely illustrative, for example, the division of modules is only a division of logical functions, and there may exist other manners of division in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device or unit, and may be electrical, mechanical, or otherwise.

Separated modules as illustrated may or may not be physically separated. Components or parts displayed as modules may or may not be physical modules, and may reside at one location or may be distributed to multiple networked units. Some or all of the modules may be selectively adopted according to practical needs to achieve desired objectives of the disclosure.

Various functional modules described in embodiments herein may be integrated into one processing module or may be present as a number of physically separated modules, and two or more modules may be integrated into one. The integrated module may take the form of hardware, or hardware plus a software functional unit.

It may be understood by those of ordinary skills in the art that, all or part of the above embodiments may be accomplished by means of hardware associated with program codes, and the above-mentioned programs may be stored in computer-readable storage mediums. The program implements the above operations in embodiments of the disclosure when executed. The storage mediums include mediums that can store program codes, such as a ROM, a magnetic disc, an optical disc, etc.

The above-mentioned integrated units of the disclosure may be stored in a computer readable storage medium if the above methods are implemented as software functional modules and sold or used as standalone products. Based on such understanding, the technical solution of the disclosure may be essentially embodied as software products, or a part of the technical solution of the disclosure that contributes to the prior art may be embodied as software products. The computer software products are stored in a storage medium and may include multiple instructions that, when executed, can cause a computing device to execute some or all operations in the methods described in embodiments of the disclosure. The storage mediums include mediums that can store program codes, such as a ROM, a magnetic disc, an optical disc, etc.

The technical solutions described in various method embodiments may be combined with each other without conflict, to obtain a new method embodiment.

The features described in various product embodiments may be combined with each other without conflict, to obtain a new product embodiment.

The features described in various method or apparatus embodiments may be combined with each other without conflict, to obtain a new method or apparatus embodiment.

The above are merely specific embodiments of the disclosure and are not intended to limit the scope of protection of the disclosure. Any modification and replacement made by those skilled in the art within the technical scope of the disclosure shall be included in the scope of protection of the disclosure. Therefore, the scope of protection of the disclosure should be stated in the scope of protection of the claims.

What is claimed is:

1. A virtual view drawing method, comprising:
generating a first visibility map and a first texture map of a target view according to an atlas of a source view;
determining a number of segmented regions;
performing region segmentation on the first texture map according to the number of segmented regions to obtain a region segmentation result;
determining a parameter representing segmentation performance according to the region segmentation result;
performing region re-segmentation on the first texture map when the parameter representing segmentation performance does not satisfy a first condition, until a second condition is satisfied or the parameter representing segmentation performance satisfies the first condition, to obtain a final region segmentation result of the first texture map, wherein the region re-segmentation comprises:
adjusting the number of segmented regions;
performing segmentation on the first texture map according to the adjusted number of segmented regions, to obtain a new region segmentation result; and
determining the parameter representing segmentation performance according to the new region segmentation result;
updating pixels to-be-updated in a region in the first visibility map corresponding to a segmented region in the first texture map according to the final region segmentation result of the first texture map, to obtain a second visibility map; and
shading the second visibility map to obtain a second texture map of the target view.

2. The method of claim 1, wherein determining the number of segmented regions comprises:
determining an image resolution of the first texture map; and
determining the number of segmented regions according to the image resolution and a preset average number of pixels of the segmented regions.

3. The method of claim 1, wherein the parameter representing segmentation performance comprises a segmentation accuracy of the region segmentation result, and wherein determining the segmentation accuracy according to the region segmentation result comprises:
classifying pixels in a segmented region in the first visibility map with the region segmentation result as a region segmentation result of the first visibility map, to obtain first-type pixels and second-type pixels;
determining whether the segmented region is an inaccurate segmented region according to a relationship between the first-type pixels and the second-type pixels; and
determining the segmentation accuracy according to a number of inaccurate segmented regions in the first visibility map.

4. The method of claim 3, wherein determining whether the segmented region is the inaccurate segmented region according to the relationship between the first-type pixels and the second-type pixels comprises:
determining an absolute value of a difference between a pixel-value representative of the first-type pixels and a pixel-value representative of the second-type pixels;
determining a first result of dividing a number of the first-type pixels by a number of the second-type pixels; and
determining the segmented region as the inaccurate segmented region when the following conditions are satisfied:
the absolute value of the difference is greater than a first threshold;
the first result is less than a second threshold; and
the first result is greater than a reciprocal of the second threshold.

5. The method of claim 4, wherein the first threshold is in a range of [25, 33], and the second threshold is in a range of [5, 10].

6. The method of claim 3, wherein determining the segmentation accuracy according to the number of inaccurate segmented regions in the first visibility map comprises:
determining a proportion of inaccurate segmented regions in the region segmentation result as the segmentation accuracy;
and wherein the parameter representing segmentation performance comprises an average number of pixels of segmented regions; and the method further comprises:
determining the average number of pixels with the region segmentation result as the region segmentation result of the first visibility map;
determining that the parameter representing segmentation performance satisfies the first condition, when the segmentation accuracy is less than or equal to a third threshold or the average number of pixels is less than or equal to a fourth threshold; and
determining that the parameter representing segmentation performance does not satisfy the first condition, when the segmentation accuracy is greater than the third threshold and the average number of pixels is greater than the fourth threshold.

7. The method of claim 1, further comprising:
taking the final region segmentation result of the first texture map as a region segmentation result of each of first visibility maps of adjacent N frames, wherein N is greater than 0.

8. The method of claim 3, further comprising:
obtaining a number of the first-type pixels and a pixel-value representative of the first-type pixels;
obtaining a number of the second-type pixels and a pixel-value representative of the second-type pixels; and
determining pixels to-be-updated in the segmented region, according to the relationship between the number of the first-type pixels and the number of the second-type pixels and the relationship between the pixel-value representative of the first-type pixels and the pixel-value representative of the second-type pixels.

9. The method of claim 8, wherein determining the pixels to-be-updated in the segmented region according to the relationship between the number of the first-type pixels and the number of the second-type pixels and the relationship between the pixel-value representative of the first-type pixels and the pixel-value representative of the second-type pixels comprises:
determining the second-type pixels as the pixels to-be-updated in the segmented region, when a second result of subtracting the pixel-value representative of the second-type pixels from the pixel-value representative of the first-type pixels is greater than or equal to a fifth threshold, and when a first result of dividing the number of the first-type pixels by the number of the second-type pixels is greater than or equal to a sixth threshold; and
determining the first-type pixels as the pixels to-be-updated in the segmented region, when a third result of subtracting the pixel-value representative of the first-type pixels from the pixel-value representative of the second-type pixels is greater than or equal to the fifth threshold, and when a fourth result of dividing the number of the second-type pixels by the number of the first-type pixels is greater than or equal to the sixth threshold.

10. The method of claim 1, wherein updating the pixels to-be-updated in the region in the first visibility map corresponding to the segmented region in the first texture map to obtain the second visibility map comprises:
updating pixel values of the pixels to-be-updated in the region in the first visibility map according to pixel values of pixels other than the pixels to-be-updated in the region in the first visibility map, to obtain the second visibility map.

11. A rendering method, comprising:
generating a first visibility map and a first texture map of a target view according to an atlas of a source view;
determining a number of segmented regions;
performing region segmentation on the first texture map according to the number of segmented regions to obtain a region segmentation result;
determining a parameter representing segmentation performance according to the region segmentation result;
performing region re-segmentation on the first texture map when the parameter representing segmentation performance does not satisfy a first condition, until a second condition is satisfied or the parameter representing segmentation performance satisfies the first condition, to obtain a final region segmentation result of the first texture map, wherein the region re-segmentation comprises:
adjusting the number of segmented regions;
performing segmentation on the first texture map according to the adjusted number of segmented regions, to obtain a new region segmentation result; and
determining the parameter representing segmentation performance according to the new region segmentation result;
updating pixels to-be-updated in a region in the first visibility map corresponding to a segmented region in the first texture map according to the final region segmentation result of the first texture map, to obtain a second visibility map;
shading the second visibility map to obtain a second texture map of the target view; and
generating a target viewpoint of the target view according to the second texture map of the target view.

12. The method of claim 11, wherein determining the number of segmented regions comprises:
determining an image resolution of the first texture map; and
determining the number of segmented regions according to the image resolution and a preset average number of pixels of the segmented regions.

13. The method of claim 11, wherein the parameter representing segmentation performance comprises a segmentation accuracy of the region segmentation result, and wherein determining the segmentation accuracy according to the region segmentation result comprises:
classifying pixels in a segmented region in the first visibility map with the region segmentation result as a region segmentation result of the first visibility map, to obtain first-type pixels and second-type pixels;
determining whether the segmented region is an inaccurate segmented region according to a relationship between the first-type pixels and the second-type pixels; and
determining the segmentation accuracy according to a number of inaccurate segmented regions in the first visibility map.

14. The method of claim 13, wherein determining whether the segmented region is the inaccurate segmented region according to the relationship between the first-type pixels and the second-type pixels comprises:
determining an absolute value of a difference between a pixel-value representative of the first-type pixels and a pixel-value representative of the second-type pixels;
determining a first result of dividing a number of the first-type pixels by a number of the second-type pixels; and
determining the segmented region as the inaccurate segmented region when the following conditions are satisfied:
the absolute value of the difference is greater than a first threshold;
the first result is less than a second threshold; and
the first result is greater than a reciprocal of the second threshold.

15. The method of claim 14, wherein the first threshold is in a range of [25, 33], and the second threshold is in a range of [5, 10].

16. A decoding method, comprising:
decoding an input bitstream to obtain an atlas of a source view;
generating a first visibility map and a first texture map of a target view according to the atlas of the source view;
determining a number of segmented regions;
performing region segmentation on the first texture map according to the number of segmented regions to obtain a region segmentation result;
determining a parameter representing segmentation performance according to the region segmentation result;
performing region re-segmentation on the first texture map when the parameter representing segmentation performance does not satisfy a first condition, until a second condition is satisfied or the parameter representing segmentation performance satisfies the first condition, to obtain a final region segmentation result of the first texture map, wherein the region re-segmentation comprises:
adjusting the number of segmented regions;
performing segmentation on the first texture map according to the adjusted number of segmented regions, to obtain a new region segmentation result; and
determining the parameter representing segmentation performance according to the new region segmentation result;
updating pixels to-be-updated in a region in the first visibility map corresponding to a segmented region in the first texture map according to the final region segmentation result of the first texture map, to obtain a second visibility map;
shading the second visibility map to obtain a second texture map of the target view; and
generating a target viewpoint of the target view according to the second texture map of the target view.

17. The method of claim 16, wherein the parameter representing segmentation performance comprises a segmentation accuracy of the region segmentation result, and wherein determining the segmentation accuracy according to the region segmentation result comprises:
classifying pixels in a segmented region in the first visibility map with the region segmentation result as a region segmentation result of the first visibility map, to obtain first-type pixels and second-type pixels;
determining whether the segmented region is an inaccurate segmented region according to a relationship between the first-type pixels and the second-type pixels; and
determining the segmentation accuracy according to a number of inaccurate segmented regions in the first visibility map.

18. The method of claim 17, wherein determining the segmentation accuracy according to the number of inaccurate segmented regions in the first visibility map comprises:
determining a proportion of inaccurate segmented regions in the region segmentation result as the segmentation accuracy;
and wherein the parameter representing segmentation performance comprises an average number of pixels of segmented regions; and the method further comprises:
determining the average number of pixels with the region segmentation result as the region segmentation result of the first visibility map;
determining that the parameter representing segmentation performance satisfies the first condition, when the segmentation accuracy is less than or equal to a third threshold or the average number of pixels is less than or equal to a fourth threshold; and
determining that the parameter representing segmentation performance does not satisfy the first condition, when the segmentation accuracy is greater than the third threshold and the average number of pixels is greater than the fourth threshold.

19. The method of claim 16, further comprising:
taking the final region segmentation result of the first texture map as a region segmentation result of each of first visibility maps of adjacent N frames, wherein N is greater than 0.

20. The method of claim 17, further comprising:
obtaining a number of the first-type pixels and a pixel-value representative of the first-type pixels;
obtaining a number of the second-type pixels and a pixel-value representative of the second-type pixels; and
determining pixels to-be-updated in the segmented region, according to the relationship between the number of the first-type pixels and the number of the second-type pixels and the relationship between the pixel-value representative of the first-type pixels and the pixel-value representative of the second-type pixels.
